(19) United States
(12) Patent Application Publication
(10) Pub. No.: US 2025/0035433 A1
(43) Pub. Date: Jan. 30, 2025

(54) MEASURING UNIT AND METHOD FOR OPTICALLY MEASURING OBJECTS

(71) Applicants: Carl Zeiss GOM Metrology GmbH, Braunschweig (DE); Carl Zeiss Industrielle Messtechnik GmbH, Oberkochen (DE)

(72) Inventors: Michael Jörck, Braunschweig (DE); Torsten Semsch, Samerberg (DE); Thorsten Bothe, Braunschweig (DE); Tim Winter, Braunschweig (DE)

(21) Appl. No.: 18/912,534

(22) Filed: Oct. 10, 2024

Related U.S. Application Data
(63) Continuation of application No. PCT/EP2023/058534, filed on Mar. 31, 2023.

(30) Foreign Application Priority Data
Apr. 11, 2022 (DE) 10 2022 108 738.7

(51) Int. Cl. G01B 11/25; G03B 21/20

(52) U.S. Cl. CPC G01B 11/2545; G03B 21/2033; G03B 21/206; G03B 21/208

(57) ABSTRACT

A measuring apparatus for optically measuring objects includes a camera and a laser projection unit which has a laser light source. The laser projection unit is configured to project laser light onto an object to be measured and the camera is configured to record an image of the object with the projected laser light. The measuring apparatus is configured to supply the at least one laser light source with a driving power which varies during each exposure time of the camera, in particular, a varying injection current and/or driving voltage, in order to increase the bandwidth of the projected laser wavelengths.

### CROSS REFERENCE TO RELATED APPLICATIONS

This application is a continuation application of international patent application PCT/EP2023/058534 filed on Mar. 31, 2023, designating the United States and claiming priority from German application 10 2022 108 738.7, filed Apr. 11, 2022, and the entire content of these applications is incorporated herein by reference.

### TECHNICAL FIELD

The disclosure relates to a measuring device for optically measuring objects, including an image recording unit and a laser projection unit having a laser light source, wherein the laser projection unit is configured to project laser light onto an object to be measured and the image recording unit is configured to record images of the object with the projected laser light.

The disclosure furthermore relates to a method for optically measuring objects with projecting laser light onto the object to be measured with a laser projection unit having a laser light source, and recording images of the object with the projected laser light with an image recording unit. In particular, the disclosure relates to a triangulating three-dimensional (3D) measuring unit, which then determines the 3D co-ordinates of the object from the recorded images of the object, for example computer-aided with appropriate evaluation software.

### BACKGROUND

For measuring objects, triangulating optical measurement with an image recording unit and a laser-based pattern generator is well known.

DE 10 2010 018 979 A1 describes a method and an apparatus for determining the 3D coordinates of an object by scanning the surface with a line scanner. The line scanner includes a projector with a laser light source and a camera for recording a projection line generated on the surface of the object by the projector.

DE 198 55 478 B4 likewise discloses a method and an apparatus for optically capturing a contrast line using a laser scanner. The contrast line is detected by virtue of the intensity of the beam emitted by the laser scanner being controlled in a manner such that the intensity of the remitted beam from the detector of the laser scanner always assumes a constant value.

DE 10 2017 212 371 B4 proposes for scanning a scene by way of a laser scanner to capture the surface coordinates successively in several capturing processes, wherein the frequency of a repeated irradiation of the scene with laser radiation and capturing of the radiation reflected by the scene by way of the laser scanner differs from one another in the successive capturing processes.

DE 10 2018 127 221 B4 describes a coordinate measurement system including a laser line scanner and a projection unit. The laser line scanner generates a laser beam, which is fanned by a suitable optical unit and projected onto the surface of the workpiece in the form of a laser line. The length of the laser line is defined by way of a working distance between the scanning module and the workpiece surface and an aperture angle of the fanned laser beam.

DE 10 2018 211 913 A1 describes an apparatus for capturing an object surface with a beam generation device. In the process, electromagnetic radiation with at least two different wavelengths is projected onto an object surface in order to generate separate measurement values based on the different reflected radiation components with each of these wavelengths. The occurrence of radiation interference for example in the form of speckle phenomena is dependent on the selected wavelength of the emitted radiation. In the case of speckle phenomena, spots of different radiation intensity appear in the irradiated region of the object surface. They can appear on account of the fact that interference occurs in the case of emitted radiation owing to interaction with an optical unit of the radiation generation device. Using radiation with at least two wavelengths increases the likelihood that the back-reflected radiation of at least one of the wavelengths and at least one of the measurement values produced therefrom have been falsified to a lesser extent than the further measurement value due to speckle or other wavelength-dependent aberrations.

### SUMMARY

Proceeding herefrom, it is an object of the present disclosure to provide an improved measurement device for optically measuring objects, which reduces in particular disturbances due to interference.

The object is achieved by the measuring device and the method for optically measuring objects as described herein.

It is proposed that the measuring device is configured to supply the laser light source with driver power varying during an exposure time of the image recording unit in each case, in particular varying injection current and/or varying driver voltage, to increase the bandwidth of the projected laser wavelengths.

The indefinite term “a” /“an” is to be understood within the meaning of the present disclosure not as a numeral, but as an indefinite term in the sense of “at least one”. Consequently, the features specified by “an element” also include within their meaning a plurality of such elements, such as a plurality of image recording units or an image recording unit with one or more cameras, laser projection units, and/or laser light sources. In addition, further, other elements are not ruled out.

Owing to the varying driver power, the spectral bandwidth of the light source which is effective during the time period in which the image of the object is recorded by way of an image recording unit is increased, resulting in a reduction in disturbances due to micro-interference. Although disturbances still occur during the image recording, they are recorded only for a very short time for a wavelength range and change due to the wavelength change brought about by the varying injection current. As a result, the weakened disturbances in the image blur and are visible only in a significantly weakened form.

Owing to the variation of the injection current, the laser light source can be modulated during the relatively short exposure times of image recording units in the order of milliseconds. The varying current changes the temperature, resulting in a change in resonator length and thus to the change in the wavelength. This makes slow modulation possible.

Owing to the variation in the driver voltage, the band model of the laser diode changes, resulting in a change in the amplification profile and thus to a change in wavelength. This makes fast modulation possible.

Depending on the requirements, the driver power may be varied either by a variation only in the injection current or only in the driver voltage in order to selectively achieve slow or fast modulation. However, it is also conceivable to use a combination of varying the injection current and the driver voltage for varying the driver power in order to combine the different effects with the different time behaviors.

Rather than operating the laser light source, in particular a laser diode, as is typical with a constant injection current, the current is modulated during the exposure time of the image recording unit. Here, at least two effects ensure the variation in the emitted wavelength:
a) thermal modulation of the laser junction temperature due to altered heat input due to the losses caused by the current. In this case, the length of the laser resonator formed through the semiconductor laser, and thus the wavelength, changes. The rule here is that the wavelength becomes longer as the temperature increases.
b) shift in the energy level of the semiconductor junction of the laser diode de-pending on the modulated current density. This is known under the term quantum-confined Stark effect. This changes the energy and thus the wavelength of the induced photons at the semiconductor. This effect depends on the semi-conductor material. In the case of blue laser diodes, the wavelength is shortened with a higher current density. In the case of red laser diodes, the effect is inverse. Higher currents generate larger wavelengths.
c) a particularly large effect occurs in combination with a wavelength shortened by a short pulse with subsequent heating and thus an increased wavelength.

The bandwidth of the projected laser wavelengths can be increased by varying the injection current, in that the wavelength of the laser light source is changed very quickly due to the varying injection current.

The laser light source can typically be a semiconductor laser. In this way, the aforementioned effects of the thermal modulation and of the quantum-confined Stark effect can be used.

Particularly simple modulation of the laser light source with a varying injection current is achieved with a pulse-modulated injection current. Here, the injection current may even be significantly increased and lie above the permissible current for the laser light source, provided the energy lies below the level of damage being done to the laser light source (for example laser diode).

The pulse modulation can be effected, for example, by pulse width modulation, pulse density modulation and the like of the injection current and/or of the driver voltage. However, also conceivable are other pulse shapes, such as a triangular, sawtooth-shaped or sinusoidal injection current profile or driver voltage profile.

The injection current can also be varied by temporally shaped injection current pulses, which have a varying current in each case in a current pulse. With such current pulse shaping, the efficiency can be further increased and the power load for the laser light source can be reduced. Similar is true for the variation in the driver voltage due to temporally shaped driver voltage pulses.

The laser projection unit can be configured for the power supply of the laser light source with modulated current pulses with pulse sequences ranging from 10 nanoseconds to 10 microseconds and a duty cycle ranging from 5 to 500. In this way it is possible in a particularly efficient and reliable manner within the short exposure times which are typical for optical measurements to achieve a bandwidth of the laser wavelengths projected onto the object by the laser light which is sufficiently large to prevent effects due to micro-interferences.

The laser projection unit can be configured to project blue laser light in the wavelength range from 440 to 470 nanometers. In the case of blue light in this wave-length range, the effect of the wavelength change resulting from the variation of the injection current is very pronounced.

The laser projection unit may include a diffractive optical element (DOE), a Powell lens and/or a wavelength-dependent grating, through which laser light generated by the laser light source is guided. In this way, the effect of the blurring of the micro-interference points brought about by the wavelength change during the image recording can be increased further even before the light exits due to interference at the DOE or grating. For a diffractive optical element, DOE, low orders make sense to prevent too much blur of the laser lines.

A suitable laser projection unit is, for example, a laser line generator, a multiline generator, or a random dot matrix generator. Also conceivable are other types of laser projection units.

The effects caused by micro-interferences can be reduced further by the laser light source being connected to an optical fiber. The wavelength difference then leads to a significant change in the spatial and temporal coherence for different wavelengths due to the optical fiber. This is dependent on the length of the optical fiber, which should be selected to be sufficiently long to achieve a perceivable effect. The light coupled into the optical fiber is mixed by multi-reflections within the optical fiber. Each partial wavelength has its own reflection angles and thus path lengths on its way through the fiber material. The path length difference increases depending on the fiber length, with the result that the light leaving the light guide has a spatially and temporally decreased degree of coherence at the light exit compared with the input-coupled light. This process should be viewed over a defined time period in which the wavelength changes take place.

This effect can be further amplified by laying the optical fibers in the form of loops.

The laser light exiting the optical fiber can be collimated using an optical lens. The collimated point-type laser light can be guided through a Powell lens to generate a laser line.

### BRIEF DESCRIPTION OF THE DRAWINGS

The disclosure will now be described with reference to the drawings wherein:

FIG. 1 shows a block diagram of a measuring device for optically measuring objects, including a camera and a laser projection unit;

FIG. 2 shows an exemplary diagram of a spectral bandwidth of a laser diode as a function of the injection current;

FIG. 3 shows a diagram of an exemplary phase contrast as a function of the normalized beam diameter for determining the spatial coherence;

FIG. 4 shows a diagram of a laser beam, which is directed at an object and guided through a diffractive optical element, having two different wavelengths;

FIG. 5 shows a diagram of a laser light source having, connected thereto, an optical fiber for lowering the degree of coherence; and

FIG. 6 shows a diagram of an arrangement of a laser light source, optical fiber, collimation lens, and Powell lens for generating a laser line.

### DESCRIPTION OF EXEMPLARY EMBODIMENTS

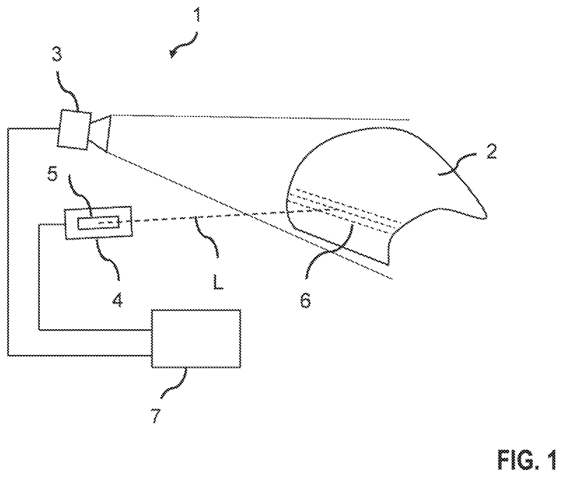

FIG. 1 shows a block diagram of a measuring device 1 for optically measuring objects 2, including an image recording unit 3 and a laser projection unit 4. It is conceivable that the image recording unit uses a single camera or a plurality of cameras, such as for example a stereo camera, for recording the object 2 or part of the object 2.

The laser projection unit 4 includes a laser light source 5, which is configured to emit a laser light beam. The laser light source 5 can include, for example, a semiconductor laser.

The laser projection unit 4 is, like the image recording unit 3, directed at the object 2 in a manner such that the laser light beam L is incident on the surface of the object 2 and illuminates the surface. The image recording unit 3 is directed at the surface of the object 2 in a manner such that it records the projected laser light structures, such as lines 6, so that the images recorded in this way can be used with triangulating methods to determine properties of the surface of the object, such as object coordinates.

Owing to the coherent properties of the laser light, interference phenomena appear on the illuminated surface of the object 2. These are also referred to as micro-interference points. They are formed by coherent laser light beams reflected by non-reflective surfaces. The magnitudes of these micro-interference points correlate with the wavelength, the temporal and spatial coherence length and the roughnesses on the reflecting surface. Micro-interference points falsify the measurement result due to constructive or destructive interference. For the human eye or an image recording unit 3, the result is a large contrast difference. The position of a micro-interference point is also dependent on the angle and the distance at which a micro-interference point is viewed. When viewing one and the same micro-interference point from the respective one other direction using an image recording unit 3 having two cameras, the position of the micro-interference point for each of these cameras lies at a different position.

The image recording unit 3 and the laser projection unit 4 are connected to a control unit 7, which is configured to control the laser projection unit 5 and the image re-cording unit 3. The images recorded by the image recording unit 3 can be received by the control unit 7 and be at least buffered. The control unit 7 can additionally also have an evaluation unit and be configured, for example by way of a suitable computer program, to evaluate by triangulation the images recorded using the image recording unit 3.

The measuring device 1 is configured to supply the laser light source 5 of the laser projection unit 4 with a varying injection current during in each case one exposure time of the image recording unit 3 in order to thus increase the bandwidth of the projected laser wavelengths of the laser beam L. The injection current can be varied by an electronic system of the laser projection unit 4. It can also be varied by the control unit 7 or by a modulation specified by the control unit 7 in combination with an electronic system of the laser projection unit 4.

Owing to the supply of the laser light source with a varying injection current, the current is modulated during the exposure time of the image recording unit 3 and in this way the emitted wavelength of the laser light beam L is varied.

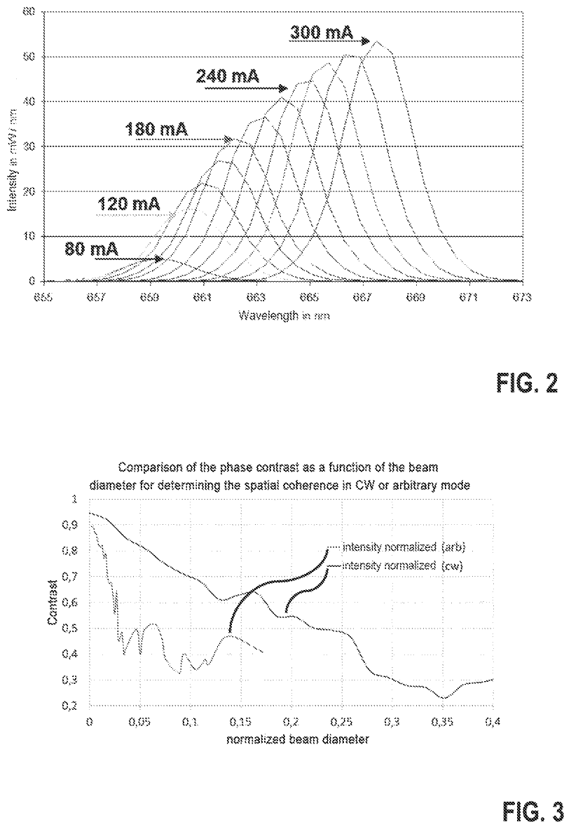

The relationship used herefor between the thermal modulation of the laser junction temperature due to a varying heat input due to the losses caused by the current and the shift in the energy level of the semiconductor junction of the laser diode, as a function of the modulated current density, will be explained with reference to FIGS. 2 and 3.

FIG. 2 shows an exemplary diagram of the spectral bandwidth of a laser diode, which is dependent on the injection current.

Every laser has a defined spectral width which is dependent, among other things, on the injection current and the cooling of the laser diode. The exemplary diagram of FIG. 2 shows different spectra of a laser diode with different current supplies. Shown here is a clear peak wavelength with a varying injection current. Thus, the peak wavelength increases as the injection current increases. At the same time, the intensity of the laser light emitted by the laser also increases as the injection current increases.

Additionally, the wavelength also increases over the short time period of the laser being heated, even if the current is constant. This dynamic effect additionally aids in the increase of the bandwidth. However, this effect is not sufficient for the relatively short exposure times, and so this inherent property is increased by varying the driver power.

FIG. 3 shows a diagram of an exemplary phase contrast as a function of the normalized beam diameter for determining the spatial coherence.

Due to the increase in temperature caused by a higher injection current, a laser resonator of the semiconductor laser formed through a semiconductor element becomes longer and the bandgap of the p-n junction decreases, causing a shift in the peak wavelengths to longer wavelength ranges. Due to an appropriate modulation of the injection current in terms of its amplitude, different wavelengths are emitted by the laser diode. Averaged over time, this yields a cumulative spectrum.

When the coherence is now determined via the cumulative spectra, modulated over current changes, a reduction in coherence can be determined.

This is shown in FIG. 3. Here, the spatial (lateral) coherence is shown, which is presented as a modulated (arb) normalized intensity or as a normalized intensity measured in cw-operation (cw).

The figure clearly shows that there is a difference with respect to the degree of coherence. The shortening of the coherence achieved results, due to variation in the injection current, in a reduction of the micro-interferences.

The influence of the changes in the wavelength on the contrast brought about by micro-interferences can be amplified by the use of what is known as a diffractive optical element (DOE) and/or also by a wavelength-dependent grating.

Such optical elements, for example in particular optical wavelength-dependent gratings, steer the laser light into different orders of diffraction. The angle of the deflection is defined both by the grating constant, and also by the wavelength. With a constant grating constant but varying partial wavelength, the laser beams are diffracted or deflected differently.

At a wavelength λ1, the laser beams are redirected to a point of incidence on a surface. The reflected coherent laser light generates a plurality of micro-interference points upstream of the surface, which are detected with an image recording unit 3.

By changing the injection current during the supply of the laser light source and thus the wavelength of the laser light source, the same beam which was previously redirected into the point of incidence is redirected into a new, shifted point of incidence on the surface. The result of this is that the points brought about by micro-interferences shift and generate new points, which are detected by the image re-cording unit 3.

By varying the injection current during the exposure time of the image recording unit 3, the wavelength change effected during the exposure time leads to blurring of the micro-interference points, which shift due to the variations in the injection current, in the camera image.

The more wavelength changes that are carried out within an exposure time of the image recording unit 3, the better the blur of the interfering micro-interference points becomes and thus the better they are removed by averaging over time. This can also be referred to as angle diversification within a defined time window, i.e., the exposure time of the image recording unit 3.

Changing the laser diode wavelength thermally, and also due to the quantum-confined Stark effect achieves a reduction in the coherence and thus the micro-interference points. This effect can be amplified further by the wavelength-dependent angle diversification at a grating with temporal averaging.

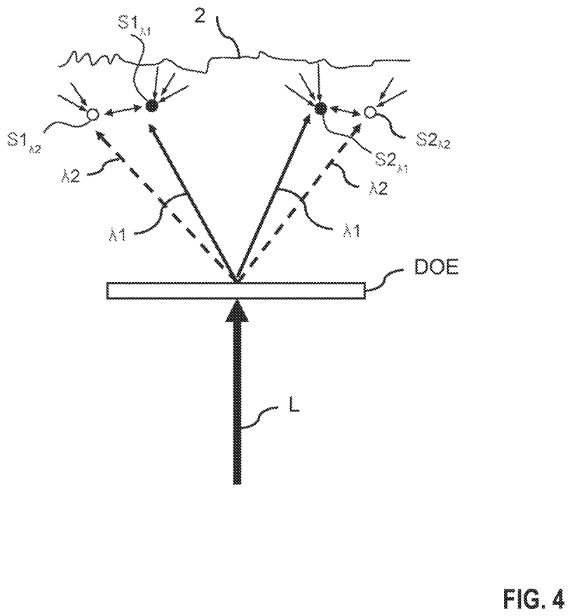

FIG. 4 shows a diagram of a laser beam with two different wavelengths 21 and 22, which is directed at an object 2 and is guided through a diffractive optical element DOE. The laser beam with zero-order of diffraction which passes through (not shown) is incident on the (uneven) surface at a first point of incidence. In the process, interferences with micro-interference points are caused by the time-of-flight differences of the laser beam at the point of incidence due to the surface roughness.

Owing to the diffraction at the diffractive optical element DOE, further points of incidence of the laser beams having a higher order of diffraction occur, which points of incidence are shifted with respect to the main point of incidence. Illustrated are the laser beams of the first order of diffraction, which exit the diffractive optical element DOE obliquely at an acute angle with respect to the first-order laser beam which passes through. The exit angle of the higher-order laser beams and thus the points of incidence on the object are dependent on the wavelengths λ1 and λ2.

In each case micro-interference points S1_{λ1}, S2_{λ1}, having the first wavelength λ1 and micro-interference points S1_{λ2}, S2_{λ2}, which are shifted with respect to the former and have the second wavelength λ2, form in front of the object 2.

At the main point of incidence, the aforementioned wavelength-dependent shifts of the micro-interference points accordingly occur even there around the main point of incidence due to the height differences on the surface. For the sake of clarity, this is not shown.

A variation in the wavelength during the recording of an image therefore has an effect for the main laser beam with zero-order of diffraction which passes through, even without the diffraction effects caused using the diffractive optical element DOE.

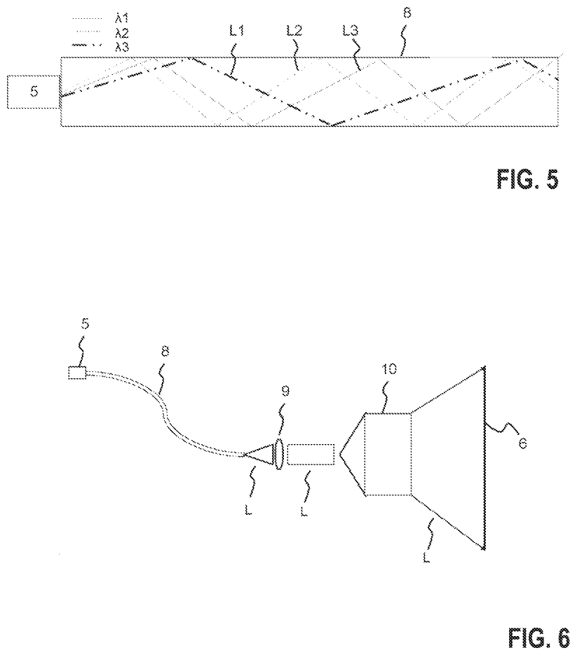

FIG. 5 shows a diagram of a laser light source 5 having, connected thereto, an optical fiber 8, through which the input-coupled laser light L from the laser light source 5 is mixed by multi-reflections and the laser light L exiting the optical fiber 8 has a degree of coherence which is significantly reduced spatially and temporally compared with the input-coupled laser light. It becomes clear that the path length difference of the laser light L1, L2, L3 at different wavelengths λ1, λ2, λ3 through the optical fiber 8 lead to a significant change in the spatial and temporal coherence. The light L1, L2, L3 in the optical fiber 8 is mixed by multi-reflections. Each partial wavelength λ1, λ2, λ3 has its own reflection angles and thus path lengths on its way through the fiber material. The path length difference becomes greater depending on the fiber length, with the result that the laser light L leaving the optical fiber 8 (light guide) has a degree of coherence which is significantly reduced spatially and temporally. This can additionally be amplified by the fact that the optical fiber 8 is laid in the form of loops, i.e., along a winding circular or meandering route. This effect can be observed over the defined time period in which the wavelength changes take place. Over an exposure time period in which the driver power is changed for example by varying the injection current and/or the driver voltage, a cumulative spectrum of all partial wavelengths is produced. This leads, averaged over time, to a widening of the total spectrum and consequently to a shortening of the coherence length, resulting in a reduction of micro-interferences and the associated effects.

FIG. 6 shows a diagram of an arrangement of a laser light source 5, optical fiber 8, collimation lens 9, and Powell lens 10 for generating a laser line. The emitted laser light L from the laser light source 5 is directly coupled into an optical fiber 8 in order to reduce the degree of coherence. The laser light L emitted at the end of the optical fiber 8 is collimated via an optical lens 9 and steered to a Powell lens 10. This Powell lens 10, in turn, generates from the point light source a laser line 6, which is projected onto an object 2 to be measured and is used to generate surface data in the measurement system. For the camera-side unambiguous detection of the laser line 6 with the best possible accuracy and determination of the line center, the laser line 6 should be as noise-free as possible. Points which are caused by micro-interferences and have different behaviors for different materials significantly deteriorate the detection result. A reduction in the micro-interferences caused by the de-scribed laser modulation consequently has a positive effect on the measurement result.

What is claimed is:

1. A measuring device for optically measuring objects, the measuring device comprising:
a camera; and
a laser projection unit having a laser light source,
wherein the laser projection unit is configured to project laser light onto an object to be measured,
wherein the camera is configured to record images of the object with the laser light projected onto the object,
wherein the measuring device is configured to supply the laser light source with a driver power varying during an exposure time of the camera, and
wherein the driver power is varied by varying at least one of an injection current and a driver voltage, to increase a bandwidth of the projected laser wavelengths.

2. The measuring device as claimed in claim 1, wherein the laser light source is a semiconductor laser.

3. The measuring device as claimed in claim 1, wherein the laser projection unit is configured to supply the laser light source with:
a pulse-modulated injection current,
a triangular, sawtooth-shaped, or sinusoidal injection current profile, or
at least one of temporally shaped injection current pulses and temporally shaped voltage pulses,
wherein each of the temporally shaped injection current pulses has a varying current,
wherein each of the temporally shaped voltage pulses has a varying voltage. and

4. The measuring device as claimed in claim 1, wherein the laser projection unit is configured to supply the laser light source with at least one of modulated current pulses and modulated voltage pulses having pulse sequences ranging from 10 nanoseconds to 10microseconds and a duty cycle ranging from 5 to 500.

5. The measuring device as claimed in claim 1, wherein the laser projection unit is configured to project blue laser light in the wavelength range from 440 to 470 nanometers.

6. The measuring device as claimed in claim 1, wherein the laser projection unit includes at least one of a diffractive optical element, a Powell lens, and a wavelength-dependent grating, through which laser light generated by the laser light source is guided.

7. The measuring device as claimed in claim 1, wherein the laser projection unit is a laser line generator, a multi-line generator, or a random dot matrix generator.

8. The measuring device as claimed in claim 1, wherein the laser light source is connected to an optical fiber.

9. The measuring device as claimed in claim 8, wherein the optical fiber is coiled in a loop-shaped manner.

10. The measuring device as claimed in claim 8, wherein an exit of the optical fiber is guided onto an optical lens for collimating the laser light and the collimated laser light exiting the optical lens is guided onto a Powell lens for generating a laser line.

11. A method for optically measuring objects, the method comprising:
projecting laser light onto the object to be measured with a laser projection unit having a laser light source;
recording, with a camera, images of the object with the projected laser light;
operating the laser light source with a driver power varying during an exposure time of the camera,
wherein the driver power is varied by varying at least one of an injection current and a driver voltage, to increase a bandwidth of the projected laser wavelengths.

12. The method as claimed in claim 11, further comprising:
operating the laser light source with:
a pulse-modulated injection current,
a triangular, sawtooth-shaped, or sinusoidal injection current profile, or
at least one of temporally shaped injection current pulses and temporally shaped voltage pulses,
wherein each of the temporally shaped injection current pulses has a varying current, and wherein each of the temporally shaped voltage pulses has a varying voltage.

13. The method as claimed in claim 12, wherein the injection current has during the exposure time at least one full wave of the injection current profile.

14. The method as claimed in claim 11, wherein the laser light source is a semiconductor laser.

15. The method as claimed in claim 11, further comprising:
operating the laser light source with at least one of modulated current pulses and modulated voltage pulses having pulse lengths ranging from 10 nanoseconds to 10 microseconds and a duty cycle ranging from 5 to 500.

16. The method as claimed in claim 11, further comprising:
projecting laser light onto the object to be measured with the laser light source in the wavelength range from 440 to 470 nanometers.

17. The method as claimed in claim 11, further comprising:
coupling laser light from the laser light source into an optical fiber to mix the input-coupled laser light by multi-reflections in the optical fiber such that light leaving the optical fiber has at a light exit of the optical fiber a degree of coherence which is reduced spatially and temporally compared with the input-coupled laser light.

18. The method as claimed in claim 17, further comprising:
guiding the laser light in the optical fiber in loops along a path which is curved at least in sections.

19. The method as claimed in claim 17, further comprising:
collimating the laser light exiting the optical fiber; and
generating a laser line from the collimated point-type laser light with a Powell lens.
